(19) United States
(12) Patent Application Publication
(10) Pub. No.: US 2018/0274241 A1
(43) Pub. Date: Sep. 27, 2018

(54) COMPOSITE PRE-CAST CONCRETE STAIR TREADS AND LANDINGS

(71) Applicants: Fred Wallace Opp, JR., Camano Island, WA (US); William Joseph Webber, JR., Marysville, WA (US); David Allen Smith, Marysville, WA (US); Philip Westley Burman, Renton, WA (US)

(72) Inventors: Fred Wallace Opp, JR., Camano Island, WA (US); William Joseph Webber, JR., Marysville, WA (US); David Allen Smith, Marysville, WA (US); Philip Westley Burman, Renton, WA (US)

(21) Appl. No.: 15/784,054

(22) Filed: Oct. 13, 2017

Related U.S. Application Data
(60) Provisional application No. 62/540,431, filed on Aug. 2, 2017.
(60) Provisional application No. 62/477,010, filed on Mar. 27, 2017.

(51) Int. Cl. E04F 11/116; E04G 13/06; E04F 11/09; B28B 11/24; B28B 13/04; B28B 7/22; B28B 23/02

(52) U.S. Cl. CPC E04F 11/116; E04G 13/062; E04F 11/09; E04F 2011/0212; B28B 13/04; B28B 7/22; B28B 23/02; B28B 11/245

(57) ABSTRACT

A pre-cast concrete stair tread is provided where the stair tread has reinforced corrugated metal embedded within the core of the concrete stair tread. The corrugations are lined up along the elongated direction of the stair tread. Concrete is poured and cured over at least one side of the corrugated metal. Additionally, the pre-cast concrete stair tread may have one or more metal straps fixed on the reinforced corrugated metal in a direction perpendicular to the corrugations and the elongated direction.

### CROSS-REFERENCE TO RELATED APPLICATIONS

This application claims priority to U.S. Provisional Application No. 62/477,010 filed Mar. 27, 2017 and Ser. No. 62/540,431 filed Aug. 2, 2017.

### TECHNICAL FIELD

The present description includes embodiments generally directed to a system and method for building staircases in commercial and/or residential locations. More specifically, the embodiments are directed generally to self-supporting pre-cast concrete stair treads and landings.

### BACKGROUND

Building and housing construction in modern cities create the demand for staircases on a massive scale. In particular, many staircases need to be built and installed in high rise buildings. In situations where heavy loads are expected, concrete staircases are often utilized to withstand heavy loads and may also be preferable to provide extra safety.

A concrete staircase typically consists of many stair treads fixed between a pair of stringers. Stair treads refer to the horizontal portion of the step of a staircase upon which individuals step or tread. The stair tread “depth” is measured from the outer edge of the step to the vertical “riser” between steps. The “width” is measured from one side to the other. Further, stringers refer to structural members that may be placed on either side of a staircase (and sometimes centrally as well). In many cases, to fix the stair treads in place, the stair treads may be fixed to each stringer, where at least one stringer is attached to one edge of a stair tread, and a second stringer attached to the opposite edge of a stair tread.

Stair treads and stringers may be pre-cast, transported to the construction site and assembled. Alternatively, stair treads and stringers are assembled off-site as separate units and transported to be installed at the construction site. In another alternative method, stringers and stair treads may be manufactured on-site by pouring concrete in a mold.

To increase the strength of stair treads under heavy loads and to prevent cracking of concrete, an existing technology imbeds metal rods—often called rebars—in the concrete along the longitudinal direction of the stair treads. However, the stair treads with rebars are still thick and heavy.

The existing methods still include many shortcomings. When manufacturing staircases on a massive scale, cost-effective manufacturing and efficient installation of staircases is highly desirable. Typically, heavy stringers and heavy stair treads provide higher strength and increase safety. On the other hand, reducing the amount of concrete and other materials in staircases is desirable in order to reduce material costs, shipping costs, and labor costs. Therefore, manufacturing relatively light-weight staircases without sacrificing strength has still not been achieved.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

There currently exists a need in the industry for relatively light-weight stair treads that are also strong and prevent cracking of concrete used to build staircases in buildings. In one embodiment, a pre-cast concrete stair tread is provided where the stair tread has reinforced corrugated metal embedded within the core of the concrete. The metal corrugations are oriented to extend along a longitudinal axis (ex. the elongated direction) of each stair tread in a stair case. Concrete may be poured and cured over one side of the corrugated metal. Alternatively, concrete may be poured and cured over both sides of the corrugated metal so that the corrugated metal is fully enclosed by the concrete.

In yet another embodiment, the pre-cast concrete stair tread has a core portion formed by a metal strap fixed on the reinforced corrugated metal in a direction perpendicular to the corrugations and perpendicular to a longitudinal axis of the stair tread. The metal strap may be bolted together with the corrugated metal. Alternatively, the metal strap may be riveted onto the corrugated metal. Still alternatively, the metal strap may be fastened onto the corrugated metal by clinching. Alternatively, the metal strap may be fastened onto the corrugated metal using other methods known by one of ordinary skill in the industry. Concrete may be poured and cured over at least one side of the core portion.

In the embodiments described above, the concrete may be cured to have a riser and run with a depth and a width adjusted to be suitable for various construction environments. The height of the stair tread may be equal to the height of a full step. Alternatively, the height of the stair tread may be approximately equal to the height of a half step. Still alternatively, the height of the stair tread may be of zero height. Additionally, the pre-cast concrete stair tread may have a plurality of retention elements to be used to fix the stair treads to a pair of stringers.

Other aspects and advantages of the invention will be apparent from the following description and the appended claims.

### BRIEF DESCRIPTION OF DRAWINGS

The present invention will be described by way of exemplary embodiments, but not limitations, illustrated in the accompanying drawings in which like references denote similar elements, and in which:

FIG. 1A is a perspective view of a prior art stair treads and landings installed on a pair of stringers.

FIG. 1B is an expanded view of the prior art stair treads and landings installed on a pair of stringers of FIG. 1A.

FIG. 2 is a side view of the prior art concrete stair tread of FIGS. 1A-1B having rebars embedded in concrete.

FIG. 3A is a perspective view of a pre-cast concrete stair tread in accordance with an illustrative embodiment.

FIG. 3B is a partial sectional perspective view of the pre-cast concrete stair tread of FIG. 3A.

FIG. 3C is a sectional side view of the pre-cast concrete stair tread of FIG. 3A.

FIG. 3D is a sectional side view of the pre-cast concrete stair tread of FIG. 3A that includes concrete covering an entirety of the piece of corrugated metal.

FIG. 4 is a partial sectional perspective view of a pre-cast concrete stair tread having metal straps in accordance with an illustrative embodiment

FIG. 5 is a side view of a pre-cast concrete stair tread having a rise of zero height in accordance with an illustrative embodiment.

FIG. 6 is a flowchart for an exemplary process of forming a stair tread.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)—(a second number),” this means a range whose limits include both numbers. For example, “25 to 100” means a range whose lower limit is 25 and upper limit is 100, and includes both 25 and 100.

As a preface to the detailed description, it should be noted that, as used in this specification, the singular forms “a”, “an”, and “the” include plural referents, unless the context clearly dictates otherwise. Like reference numbers and designations in the various drawings indicate like elements.

The present description includes one or more embodiments that are generally related to a novel and helpful system and method for building and installing staircases suitable for a variety of buildings. Further, the present description includes one or more embodiments that include corrugated metal and concrete that may be poured and set over the corrugated metal. More details are provided below with respect to the Figures.

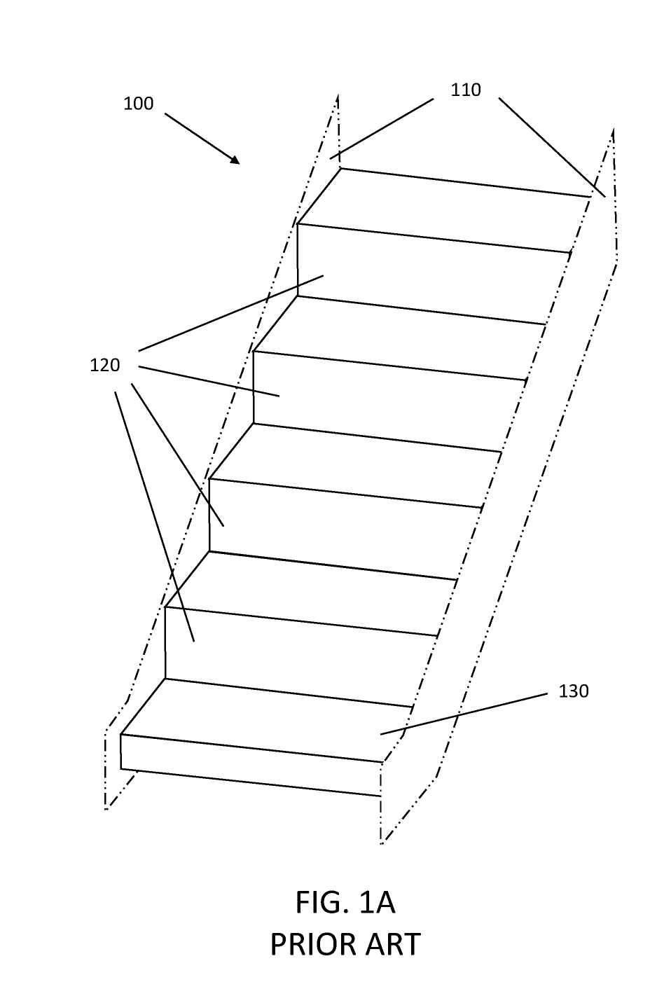

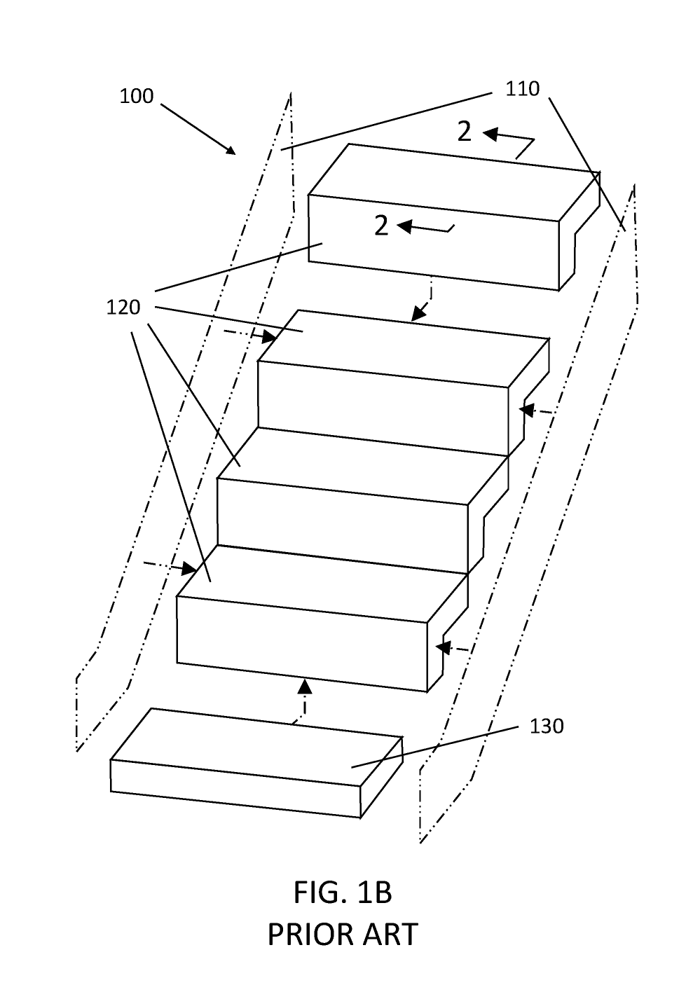

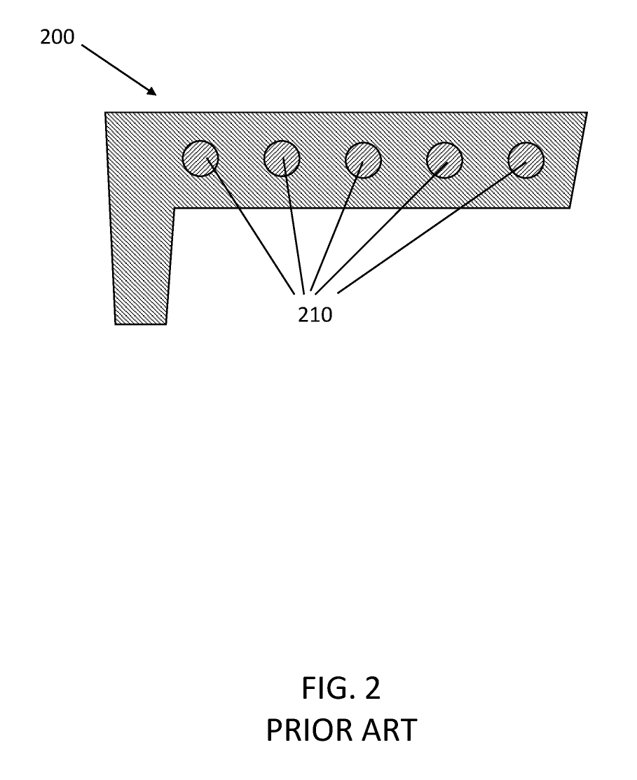

Concrete staircases are often manufactured in modules (separate individual units) that come in standardized sizes for mass production. A concrete staircase manufactured in such a modularized way may include a pair of stringers (two or more structural members that may be placed on both sides of a staircase and onto which the stair treads are fixed) and a plurality of steps or stair treads (horizontal steps of the staircase upon which individuals step or tread) fixed between the stringers. FIGS. 1A-1B and FIG. 2 are examples of such staircases that include a plurality of steps or stair treads fixed between stringers. FIG. 1A shows a pictorial example of such staircases found in the prior art. FIG. 1B is another pictorial view of the prior art staircase of FIG. 1A and includes a section line 2-2. FIG. 2 shows a sectional view taken along line 2-2 of FIG. 1B.

As shown in FIGS. 1A and 1B, a staircase 100 includes a pair of stringers 110 positioned vertically in parallel with each other and stair treads 120 positioned between the two stringers 110. As shown in FIG. 1A, a plurality of stair treads 120 are placed perpendicularly to each stringer 110 located on either side of each stair tread 120. In some cases, the stair treads 120 may be mechanically fixed to the stringers by brackets (not shown). Alternatively, the stair treads 120 may be mechanically fixed to the stringers by other fastening means. The bottom of the stringers 110 may be connected by a landing 130, which is a varied form of a stair tread 120 having a riser of zero vertical elevation.

A “riser” as used herein may refer to a near-vertical element in a set of stair treads, forming the vertical space between one stair tread and the next. The risers of the stair treads 120 may form different vertical spaces between the stair treads depending on the specific conditions of the construction site where the staircase is installed, and may also have various heights and other measurements.

In some cases, staircases 100 are pre-fabricated and pre-assembled in a factory before being transported to the construction site for installation. Alternatively, the making of staircases 100 may be performed in a more modularized fashion, whereby stair treads 120 and landings 130 are pre-fabricated in a factory and then moved to the construction site where stringers 110 are installed, and then assembled together on-site.

Referring to FIG. 2, a sectional view of an example of prior art stair treads taken along section line 2-2 from FIG. 1B. The stair tread 200 is fabricated by pouring concrete on a mold (not shown). The stair tread 200 as shown in FIG. 2 and found in prior art is reinforced by multiple metal rebars 210 that run through the concrete in a longitudinal direction. The rebars are usually formed as long bars that have cylindrical shapes (e.g. as shown in FIG. 2). Rebars are used to increase the shear strength of stair treads to meet the weight requirements. Standard industry practices usually require that stair treads be designed to withstand 40 pounds per square foot uniformly distributed live load, or a 300-pound concentrated load over an area of 4 square inches, or 1,200 pounds per square inch.

The stair treads 200 of FIG. 2 may also have a retention element (not shown) at each end of the stair tread that extends in the longitudinal direction. The retention elements have enough strength to withstand the maximum weight exerted on the stair treads. After the concrete is cured, the stair treads 200 are fixed to a pair of stringers to form a staircase, such as the staircase 110 shown in FIG. 1.

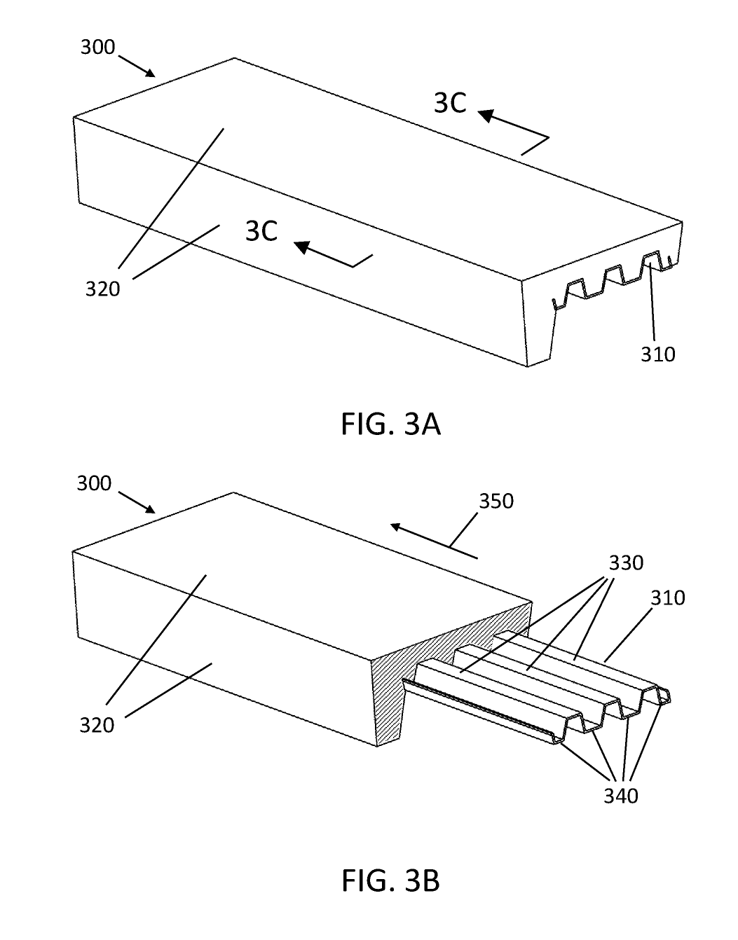

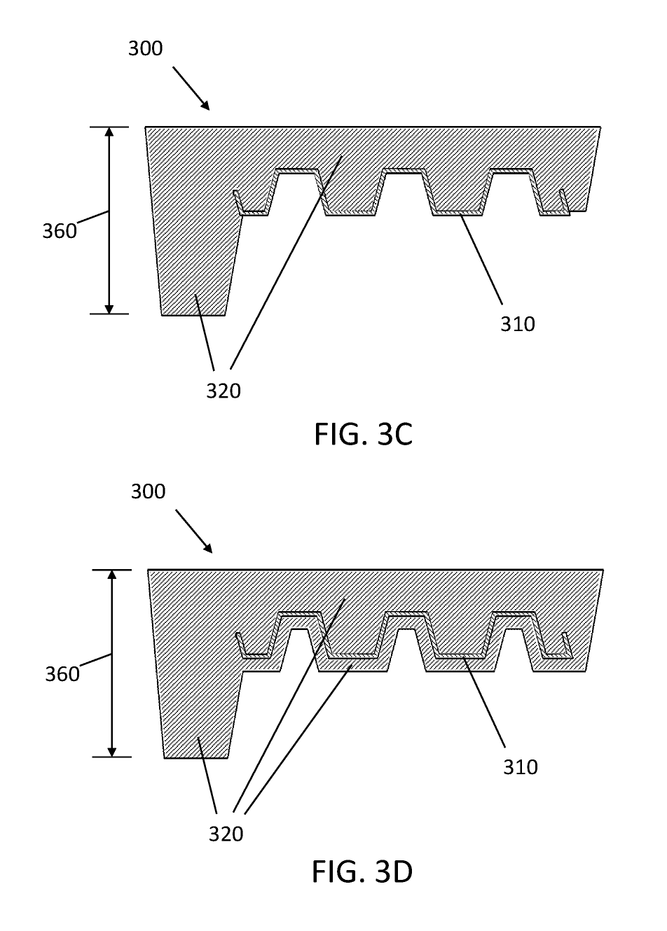

Turning to FIGS. 3A-3C, FIGS. 3A-3C provide an exemplary pre-cast concrete stair tread 300. The embodiments for a system of assembling a stair case as shown in FIGS. 3A-3C are novel and helpful in providing an alternative to existing methods and are not found in the prior art. The stair tread 300 may be pre-cast. As used herein, “pre-cast” may refer to concrete that is poured over the corrugated metal 310 and set in a mold (not shown) to be made into a stair tread before being fixed to stringers to, ultimately, form a staircase. Any concrete material known by one of ordinary skill for staircases in either residential or commercial buildings may be used. In one non-limiting, embodiment, the thickness of the concrete over the corrugated metal may be about 2.5 inches or thicker, although other thicknesses may also be used. The width of the stair tread 300 may be of any size that can accommodate the passage of people and luggage through the staircase as known by one of ordinary skill in the industry.

FIG. 3A is a perspective view of the exemplary pre-cast concrete stair tread 300 and includes a section line 3C-3C. FIG. 3C shows a side sectional view taken along line 3C-3C of FIG. 3A. The pre-cast concrete stair tread 300 includes corrugated metal 310 and concrete 320 poured over corrugated metal 310. Corrugated metal 310 forms the core portion of stair tread 300 because corrugated metal 310 is located within the main body of stair tread 300.

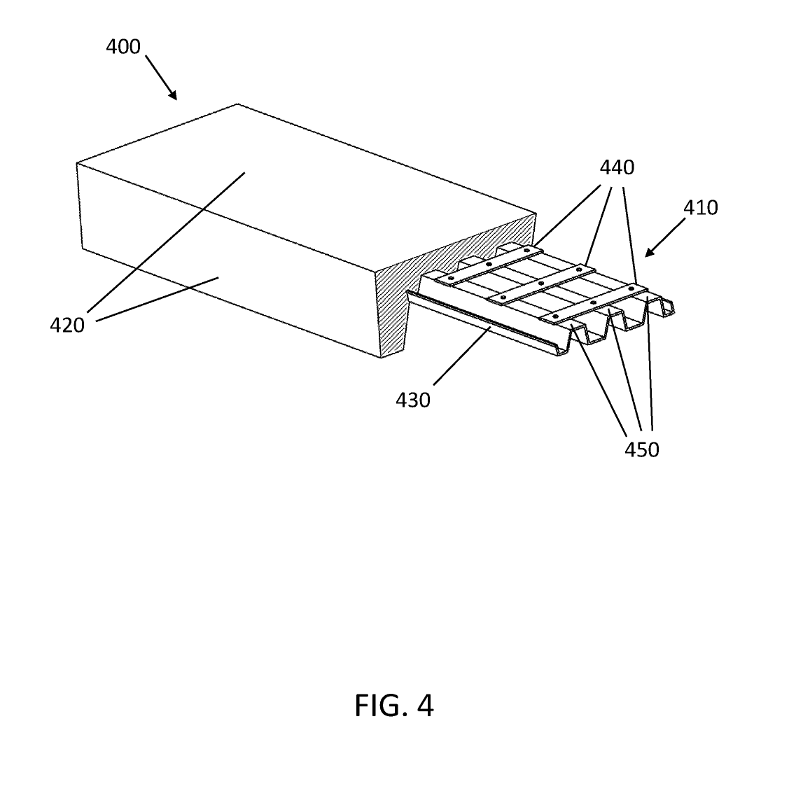

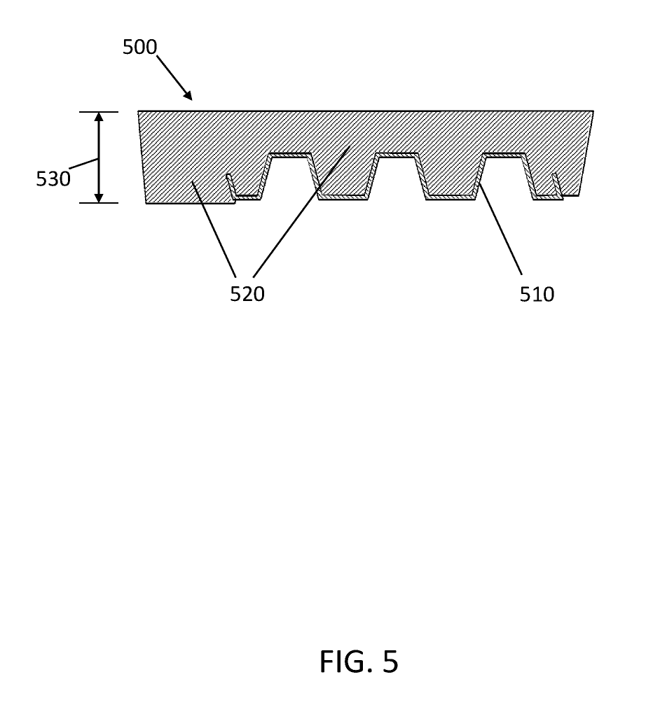

FIG. 3B is a partial sectional perspective view of the exemplary pre-cast concrete stair tread 300 shown in FIG. 3A. This partial view shows the shape of the corrugated metal 310 in more detail. The corrugated metal 310 includes multiple protrusions and depressions. The ridges 330 (i.e. protrusions) and grooves 340 (i.e. depressions) of the corrugated metal 310 may be substantially parallel to one another. As shown in FIG. 3B, a ridge 330 may be located next to a groove 340 and so on up to the terminating edge of corrugated metal 310, with upwardly and downwardly angled surfaces located between each ridge 330 and groove 340. The top surface of each ridge 330 may have its own flat portion having a predetermined width that extends in a perpendicular direction with respect to a longitudinal axis of corrugated metal 310. Corrugated metal 310 may have the shape shown in FIG. 3A-3C (as well as that shown in FIG. 4 and FIG. 5), whereby groove 340 includes an empty channel extending in the direction of arrow 350 as well as an empty channel extending on the underside of each ridge 330 in the same direction.

Further, FIG. 3B shows that corrugated metal 310 may be oriented along a longitudinal axis or lined up along the elongated direction(i.e. in the direction of the arrow 350) of the stair tread. “Longitudinal” as used herein means along the longest part of the stair tread. Corrugated metal 310 is oriented so that its longitudinal axis is parallel to the longitudinal axis of the stair tread 310. It is noted that in alternative embodiments corrugated metal 310 may have a different shape, structure, or alignment than that shown in FIGS. 3A-3C. As shown in FIGS. 3A-3C, corrugated metal 310 (i.e. piece of corrugated metal 310) may be a uniform piece, and may be manufactured in any way known by those skilled in the art.

Having a staircase that includes the reinforcing, corrugated metal 310 as shown in FIGS. 3A-3C within the core of each stair tread 300 may beneficially provide increased strength for stair tread 300 to withstand any load applied to stair tread 300. For example, in one non-limiting embodiment, a pre-cast concrete stair tread having corrugated metal within its core, such as stair tread 300 which includes corrugated metal 310, may be able to withstand a load of at least 2,500 pounds per square inch. Moreover, due to the relatively light weight of the corrugated metal 310 compared to the overall weight of concrete, the overall weight of stair tread 300 is greatly reduced as a result of use of corrugated metal 310 as shown in FIGS. 3A-3C, and further below as exemplified by corrugated metal 410 in FIG. 4 and corrugated metal 510 in FIG. 5. The reduced weight is beneficial to reducing the transportation costs from the manufacturing factory or storage to the construction site. Further, corrugated metal 310 disposed within the core of stair tread 300 may also be useful to reduce cracking of the concrete of stair tread 300, which is an ongoing problem with existing concrete stair treads.

FIG. 3C shows a side sectional view of the exemplary pre-cast concrete stair tread 300 taken along section line 3C-3C from FIG. 3A. To fabricate the pre-cast concrete stair tread 300, concrete is poured into a mold formed over the top surface of the corrugated metal 310 and cured. The concrete portion 320 may be cast in such a way that it also covers the other side of the corrugated metal 310, i.e. the bottom surface of the corrugated metal 310 in order to prevent corrosion of the corrugated metal. Likewise, the sides of the corrugated metal 310 may also be covered by concrete portion 320 so that the corrugated metal 310 is fully enclosed within the concrete portion 320.

Further, the rise 360 (also referred to herein as riser) of the stair tread 300, which becomes the height of one step, can be sized having any suitable height according to the needs and desired dimensions of a specific construction site. As shown in FIG. 5, the rise may also be of zero height (e.g. 530) so that it may be used as a landing, i.e. the bottom or top stair tread in the staircase.

FIG. 3D is another side sectional view of the pre-cast concrete stair tread 300 shown in FIG. 3A, with the concrete (e.g. concrete 320) covering an entirety of corrugated metal 310. In some embodiments, the concrete may be poured to cover primarily a top surface of the piece of corrugated metal (e.g. as shown in FIG. 3B and FIG. 3C). Alternatively, the concrete 320 may be poured to cover an entirety of the piece of corrugated metal, including a bottom surface of the piece of corrugated metal, as shown in FIG. 3D.

Referring to FIG. 4, a partial sectional perspective view of an exemplary pre-cast concrete stair tread 400 is provided. Similarly to the exemplary pre-cast concrete stair tread 300 shown in FIGS. 3A-3C, the pre-cast concrete stair tread 400 includes a core portion 410 and a concrete portion 420 poured and cast over the core portion 410. However, the core portion 410 includes corrugated metal 430 and a plurality of metal straps 440 fixed on the ridges 450 of the corrugated metal 430. The metal straps 440 may be fixed on the ridges 450 of corrugated metal 430 using conventional fastening methods for metals including using rivets, bolts and screws and welding.

Clinching may also be used to fix the metal straps 440 on the corrugated metal 430. Clinching is a method of forming a joint between two sheet metals by putting the two sheet metals between a high pressure punch and a die. The punch is generally of a cylindrical shape, and the die is also generally of a cylindrical hollow, where the hollow is slightly wider than the size of the punch. When the punch presses a small area of the two sheet metals against the die, the two sheet metals in the small area are depressed against the hollow of the die. At the same time, the die retreats slightly from the surface of the sheet metal, so that the punch leaves a protrusion on the two sheet metals that is slightly higher than the depth of the hollow of the die. When the punch is retreated, the die presses the protrusion of the sheet metals against the surface of the lower sheet metal, so that the protrusion is squeezed and balloons sideways. In this way, the two sheet metals are interlockingly joined. Because it does not use rivets, fasteners, fumes, heat or adhesives, clinching provides an efficient way to fasten the metal pieces so that the staircases using pre-cast concrete stair treads can be easily fabricated at the factory, the storage or the construction site. In one or more non-limiting embodiments, clinching elements may be provided by Norlok Technology, Inc. of Brantford, Ontario, Canada, although other providers or manufacturers may also be used in alternative embodiments.

FIG. 5 shows a side view of an exemplary pre-cast concrete stair tread 500 of the present invention, where the rise 530, or the height of one step, is of zero height. This pre-cast concrete stair tread 500 may also have metal straps fastened on top of the corrugated metal 510 similarly to the core portion 410 of FIG. 4. Stair tread 500 as shown in FIG. 5 may be used as a landing, which is a type of stair tread having zero height. Accordingly, FIGS. 3A-3C, 4, and 5 have shown various embodiments of a system and method for constructing stair treads that include reinforcing, corrugated metal within a core of the concrete also used to form the stair treads. It is noted that the unique shape and structure of corrugated metal 310 (and also 410 and 510 in FIGS. 4 and 5) provide a reinforcing, yet lightweight core portion for a stair tread.

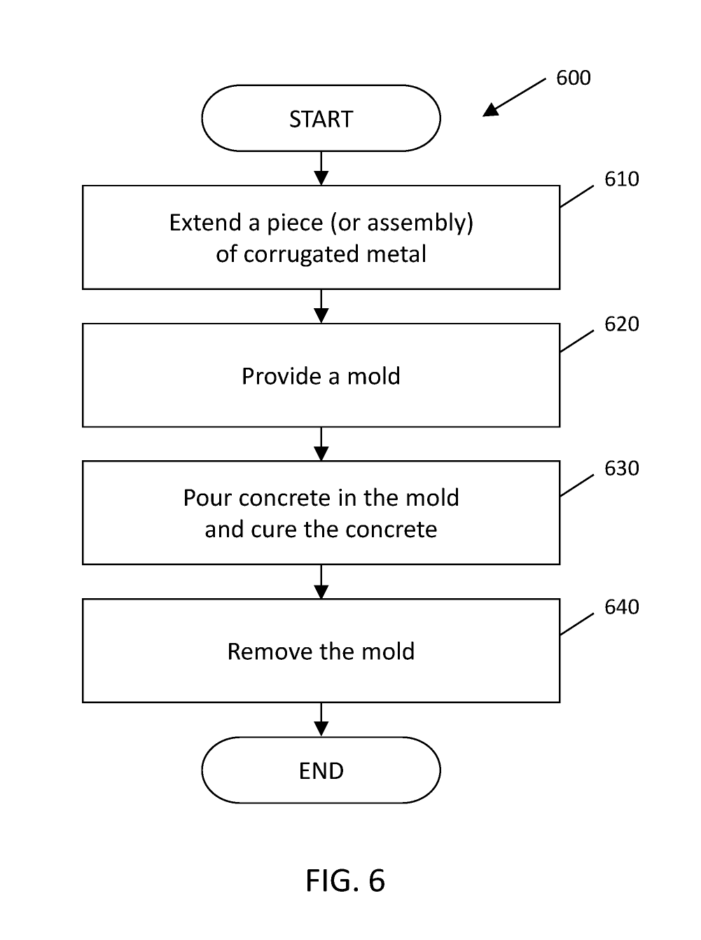

Referring to FIG. 6, an exemplary method, such as method 600, is provided for constructing and forming pre-cast concrete stair treads. Process 600 may utilize one or more elements described above with respect to FIGS. 3A-3C, FIG. 4, and FIG. 5, including stair treads 300 and corrugated metal 310.

The process may begin by extending a piece (or assembly) of corrugated metal (step 610). The corrugated metal has multiple protrusions (e.g. ridge 330) and depressions (e.g. groove 340). The ridges and grooves (depressions) of the corrugated metal may be substantially parallel to one another. The piece of corrugated metal may be oriented so that the length of the corrugated metal (e.g. corrugated metal 310, 410, or 510 as shown in FIGS. 3A-3C, 4, or 5) is oriented to extend along a longitudinal axis of the stair tread. Alternatively, the corrugation may have other structure or alignment.

Next, a mold in a desired shape of a stair tread is provided around and over the top surface of the corrugated metal (step 620). The mold serves to keep concrete in shape until the concrete cures, i.e. solidifies. The mold may provide a riser (a near-vertical element in a set of stair treads, forming the vertical space between one stair tread and the next) with a desired height for people to step up or down.

Subsequently, concrete in the liquid state is poured in the mold (step 630). The concrete in the mold is then left in place so that the concrete solidifies in the desired form. Finally, the mold is removed (step 640), leaving the concrete combined with the corrugated metal (e.g. corrugated metal 310, 410, or 510 as shown in FIGS. 3A-3C, FIG. 4, or FIG. 5). Optionally, the concrete may further be sanded down for aesthetic purposes. In addition, other materials such as a metal tread piece or a marble slab may be added on top of the cured concrete. In some embodiments, when forming the stair tread, the concrete may be poured to cover primarily a top surface of the piece of corrugated metal. Alternatively, the concrete may be poured to cover an entirety of the piece of corrugated metal, including a bottom surface of the piece of corrugated metal.

Additionally, a plurality of metal straps may be fixed to the piece of corrugated metal within a stair tread (e.g. corrugated metal 310, 410, or 510). In one or more embodiments, one or more metal straps may be fixed to either a top surface or a bottom surface of the piece of corrugated metal (e.g. corrugated metal 310, 410, or 510). As discussed above, the metal straps may be fixed on the corrugated metal using any fastening means known in the art including using fasteners (e.g. rivets, bolts, and/or screws), welding, and clinching, or any other type of fastening means available.

Optionally, a retention element may be attached at each end of the stair tread in the longitudinal direction. The retention elements may be attached before the concrete is cured. Alternatively, the retention elements may be affixed to the cured concrete. The retention elements have enough strength to withstand the maximum weight exerted on the stair treads. After the concrete is cured, the stair treads are fixed to a pair of stringers to form a staircase.

The pre-cast concrete stair treads with corrugated metal have relatively light weight compared to existing, conventionally available concrete stair treads. Because less concrete is needed than these conventional concrete stair treads when using stair treads formed in accordance with one or more embodiments provided in the present description, the cost of material is reduced. Due to the light weight of each stair tread, shipping costs are also reduced. The light weight also reduces labor costs and installation costs. Because each stair tread may be made thinner than prior art concrete stair treads, the pre-cast concrete stair treads with corrugated metal, according to embodiments described in the present description, may provide more options for the design and aesthetic aspects of building construction. Further, it is a benefit that one or more embodiments described herein enable stair treads that weigh relatively less than prior art stair treads but also are able to withstand the same amount of load and have the same strength for each stair tread as required by standard industry practices. Standard industry practices usually require that stair treads be designed to withstand 40 pounds per square foot uniformly distributed live load, or a 300-pound concentrated load over an area of 4 square inches, or 1,200 pounds per square inch. Embodiments of the stair treads described herein may be able to withstand at least these amounts, as well as other ranges without limitation thereto. Accordingly, the one or more embodiments for a stair tread described herein have numerous advantages and applications that may benefit the industry when constructing stair cases for residential or commercial buildings.

While certain exemplary embodiments have been described and shown in the accompanying drawings, it is to be understood that such embodiments are merely illustrative of and not restrictive on the broad application, and that this application is not limited to the specific constructions and arrangements shown and described, since various other modifications within the spirit of the present invention may occur to those of ordinary skill in the art.

1. A system for pre-cast concrete stair tread, the system comprising:
a core portion comprising a horizontally extending piece of corrugated metal comprising a top surface, a bottom surface, a plurality of ridges, and a plurality of grooves;
concrete adapted to cover the piece of corrugated metal; and
one or more metal straps fixedly disposed on the piece of corrugated metal and disposed substantially perpendicular to a longitudinal axis of the piece of corrugated metal.

2. The system of claim 1, wherein the concrete covers the top surface of the piece of corrugated metal.

3. The system of claim 2, further comprising a concrete portion that extends down a front surface of the stair tread, wherein the concrete portion does not cover the bottom surface of the piece of corrugated metal.

4. The system of claim 1, wherein the concrete is adapted to cover an entirety of the piece of corrugated metal.

5. The system of claim 1, wherein the piece of corrugated metal is oriented to extend in a horizontal direction along a longitudinal axis of the pre-cast concrete stair tread.

6. (canceled)

7. The system of claim 1, wherein the one or more metal straps are fixedly disposed to the top surface of the piece of corrugated metal.

8. The system of claim 1, wherein the one or more metal straps are fixedly disposed on the bottom surface of the piece of corrugated metal.

9. The system of claim 1, wherein the one or more metal straps are fixedly disposed on the piece of corrugated metal by a fastening means.

10. The system of claim 9, wherein the fastening means is operable to clinch the one or more metal straps to the piece of corrugated metal.

11. The system of claim 9, wherein the fastening means includes using a plurality of fasteners.

12. The system of claim 1, further comprising a plurality of retention elements.

13. A method for forming a concrete stair tread, the method comprising:
providing a piece of corrugated metal comprising a top surface and a bottom surface;
positioning the piece of corrugated metal such that the piece of corrugated metal is oriented along a longitudinal axis of the concrete stair tread and horizontally extending;
providing one or more metal straps fixedly disposed on the piece of corrugated metal and substantially perpendicular to a longitudinal axis of the piece of corrugated metal;
forming a mold on and around the top surface of the piece of corrugated metal;
pouring concrete in the mold covering the top surface of the piece of corrugated metal;
curing the concrete; and
removing the mold.

14. The method of claim 13, wherein the pouring of the concrete does not include covering the bottom surface of the piece of corrugated metal.

15. The method of claim 13, wherein the pouring of the concrete in the mold further comprises covering an entirety of the piece of corrugated metal so as to include a bottom surface of the piece of corrugated metal.

16. The method of claim 13, wherein the corrugated metal further comprises a plurality of ridges and a plurality of grooves that extend along the longitudinal axis of the concrete stair tread.

17. (canceled)

18. The method of claim 13, wherein providing the one or more metal straps further comprises fixedly disposing the one or more metal straps to the top surface of the piece of corrugated metal and substantially perpendicular to the longitudinal axis.

19. The method of claim 13, wherein the one or more metal straps are fixedly disposed on the piece of corrugated metal by a fastening means.

20. The method of claim 19, further comprising clinching the one or more metal straps to the piece of corrugated metal.
